SEQUENCE LISTING (2 sequences)

SEQ ID NO: 1 - DNA, 1545 bp, Bacillus licheniformis
agagtttgatcctggctcaggacgaacgctggcggcgtgcctaatacatgcaagtcgagcggacagatgggagcttgctccctgatgtcagcggcggacgggtgagtaacacgtgggtaacctgcctgtaagactgggataactccgggaaaccggggctaataccagatgcttgattgaaccgcatggttcaattataaaaggtggcttttagctaccacttacagatggacccgcggcgcattagctagttggtgaggtaacggctcaccaaggcaacgatgcgtagccgacctgagagggtgatcggccacactgggactgagacacggcccagactcctacgggaggcagcagtagggaatcttccgcaatggacgaaagtctgacggagcaacgccgcgtgagtgatgaaggttttcggatcgtaaaactctgttgttagggaagaacaagtaccgttcgaatagggcggtaccttgacggtacctaaccagaaagccacggctaactacgtgccagcagccgcggtaatacgtaggtggcaagcgttgtccggaattattgggcgtaaagcgcgcgcaggcggtttcttaagtctgatgtgaaagcccccggctcaaccggggagggtcattggaaactggggaacttgagtgcagaagaggagagtggaattccacgtgtagcggtgaaatgcgtagagatgtggaggaacaccagtggcgaaggcgactctctggtctgtaactgacgctgaggcgcgaaagcgtggggagcgaacaggattagataccctggtagtccacgccgtaaacgatgagtgctaagtgttagagggtttccgccctttagtgctgcagcaaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcctctgacaaccctagagatagggcttccccttcgggggcagagtgacaggtggtgcatggttgtcgtcagctcgtgtcgtgagatgttgggttaagtcccgcaacgagcgcaacccttgatcttagttgccagcattcagttgggcactctaaggtgactgccggtgacaaaccggaggaaggtggggatgacgtcaaatcatcatgccccttatgacctgggctacacacgtgctacaatgggcagaacaaagggcagcgaagccgcgaggctaagccaatcccacaaatctgttctcagttcggatcgcagtctgcaactcgactgcgtgaagctggaatcgctagtaatcgcggatcagcatgccgcggtgaatacgttcccgggccttgtacacaccgcccgtcacaccacgagagtttgtaacacccgaagtcggtgaggtaaccttttggagccagccgccgaaggtgggacagatgattggggtgaagtcgtaacaaggtagccgtatcggaaggtgcggctggatcacctcctttct

SEQ ID NO: 2 - DNA, 3015 bp, Bacillus licheniformis
ttgccggttacggttcttttgcgtgctcttggcttcggatctgaccaagagatcattgatctcatcggtgaaaacgagtatttgcgcaatacgcttgataaagataatacggaaaacaccgataaagcgcttcttgaaatctacgagcgtcttcgtccaggagagccgcctacagtagaaaacgcaaaaagcctgcttgattcaaggttctttgatccgaaaagatatgaccttgcaagtgtaggacgttataaaattaataaaaagcttcacatcaaaaacagactgtttaatcagcggcttgctgaaacgctgatcgatcctgaaacaggcgaaattcttgccgaaaaaggcgcgattttagacagaagaacgcttgacaaagtcctgccttaccttgaaaacggaatcggttttaaaaagctgtatccgaacggcggagttgttgaagatgaagtgacgcttcagtctattaaaatctatgccccgacagatcaagaaggggagcagacaatcaatgtgattggaaatgcttatattgaagaaggcgttaaaaatattacaccttctgatattatctcttccatcagctatttctttaacctgcttcacggagtgggcgataccgacgatatcgaccatttaggaaaccgccgtctccgttcagtgggagagcttctgcaaaaccaattccgtatcggtttaagcagaatggagcgtgttgttcgtgaaagaatgtctattcaagatacaaacacgatcacgccacagcagctgatcaatattcgccctgtcatcgcatcaatcaaagagtttttcggaagctcgcagctttctcagtttatggatcagacgaatccgcttgctgagctgacgcataagcgccgtctgtcagcgctcggaccgggcggtttgacccgtgagcgcgccggaatggaagtccgtgacgttcactattcccactacggccggatgtgtccgattgaaactcctgagggtccaaacatcggcttgatcaactcgctttcttcattcgcgaaagtgaaccgtttcggcttcatcgaaacgccgtatcgccgcgttgaccctgagactggaaaagtaacgccgagaatcgattacttgacagctgatgaagaagacaactatgtcgttgcccaggctaacgcacgtctgaatgatgacggatcttttgtggatgacagcatcgtcgcccgtttcagaggggagaacaccgttgttccgaaagaccgcgtcgactatatggacgtttcgcctaaacaggttgtctctgccgcgactgcatgtattcctttcttggaaaacgacgactcaaaccgcgccctaatgggagcgaacatgcaacggcaggctgtacctcttatgcagcctgaatctccgatcgtcggaaccggaatggagtatgtatctgcaaaagactccggtgccgctgttatttgccgccatcctggaatcgttgaacgggtggaagcgaaaaacatctgggtgcgccgctatgaagaagtcgacggccagaaagtcaaaggaaaccttgataaatacagcctgctgaagtttgttcgttccaaccagggaacttgctacaaccagcgtccgatcgtaagcgtcggtgatgaggttgtaaaaggtgaaattttagctgacggtccgtctatggaaaaaggtgagcttgcccttggacgcaacgtcatggtcggctttatgacatgggatggctacaactacgaggatgccatcatcatgagcgaacgccttgtaaaagacgacgtatacacgtctattcatattgaggaatacgaatcagaggcccgggatacaaaactcggacctgaagaaattacacgcgatattccaaacgtcggtgaagacgctcttcgcaatctcgatgaacgcggaattatccgtgtcggtgctgaagtaaaagacggagatcttcttgttggtaaagtaacgcctaaaggtgttacagagcttactgcagaagagcgcctgcttcacgccatcttcggcgaaaaagcgcgtgaagtccgcgatacgtcgctgcgtgtgcctcacggaggcggcggtatcatccttgatgtaaaagtgttcaaccgcgaagacggagacgaactgcctccgggcgttaaccagctcgtccgcgtttacatcgttcagaaacgtaaaatttctgaaggggacaaaatggccggacgccacgggaacaaaggtgttatttcgaaaatccttccggaggaagatatgccgtatctgcctgacggaacaccgattgacatcatgttaaacccgctgggcgtaccatcgcgtatgaacatcgggcaggtgttggagctgcaccttggtatggctgcacgccgtctcggtctgcatgtcgcgtcgccggtatttgacggtgcccgcgaagaagatgtgtgggaaacgcttgaagaagccggcatgtcaagggacgcaaagacagtcctttacgacggccgaactggagagccgtttgacaaccgggtgtctgtcggcatcatgtacatgatcaaattggctcacatggttgacgacaaattgcacgcgcgttctacaggtccttactcactcgttacccagcagcctcttggaggtaaagcgcagttcggtggacagcgttttggagagatggaagtttgggcgcttgaagcttacggtgcagcatatacacttcaagaaatcctgactgttaaatcggatgatgtcgtaggccgtgtgaaaacatacgaagccatcgtaaaaggcgacaatgttccagaacctggtgttccggaatcgttcaaagtattgatcaaagagcttcaaagcttaggtatggacgtcaaaatcctatcaagcgacgaagaagaaatcgaaatgagagacttggaagacgacgaagacgcgaaacaaaacgaagggctttctctgccgaatgatgaagagtccgaagaattcgtttctgctgacgcagagcgcgatgtcgtcacaaaagaataa

(19) United States
(12) Patent Application Publication
(10) Pub. No.: US 2016/0183533 A1
(43) Pub. Date: Jun. 30, 2016

(54) PLANTING MATRICES COMPRISING BACILLUS SPP. MICROORGANISMS FOR BENEFITING PLANT GROWTH

(71) Applicant: FMC CORPORATION, Philadelphia, PA (US)

(72) Inventors: Safiyh Taghavi, Chapel Hill, NC (US); Daniel van der Lelie, Chapel Hill, NC (US)

(21) Appl. No.: 14/870,477

(22) Filed: Sep. 30, 2015

Related U.S. Application Data
(60) Provisional application No. 62/097,258, filed on Dec. 29, 2014.

(51) Int. Cl. A01N 63/00

(52) U.S. Cl. CPC A01N 63/00

(57) ABSTRACT

Compositions are provided that are planting matrices containing spores of Bacillus spp. microorganisms for benefiting plant growth. The Bacillus spp. microorganisms include newly identified Bacillus licheniformis strain RTI184 deposited as ATCC No. PTA-121722 and Bacillus licheniformis CH200 deposited as Accession No. DSM 17236. Both Bacillus licheniformis strains were shown to produce previously unreported Fengycin-like and Dehydroxyfengycin-like cyclic lipopeptides that are not produced uniformly among strains of Bacillus licheniformis. The planting matrices provided include potting soils. The pH of the potting soils can range between 4 to 8. The growth benefit provided by the planting matrices can be exhibited by improved seedling vigor, improved root development, improved plant growth, improved plant health, increased yield, and improved plant appearance.

### CROSS REFERENCE TO RELATED APPLICATIONS

This application claims the benefit of U.S. provisional application No. 62/097,258 filed Dec. 29, 2014, the disclosure of which is hereby incorporated by reference in its entirety.

### TECHNICAL FIELD

The presently disclosed subject matter relates to planting matrices comprising isolated strains of Bacillus spp. microorganisms for benefiting plant growth.

### BACKGROUND OF THE INVENTION

A number of microorganisms having beneficial effects on plant growth and health are known to be present in the soil, to live in association with plants specifically in the root zone (Plant Growth Promoting Rhizobacteria “PGPR”), or to reside as endophytes within the plant. Their beneficial plant growth promoting properties include nitrogen fixation, iron chelation, phosphate solubilization, inhibition of non-beneficial microrganisms, resistance to pests, Induced Systemic Resistance (ISR), Systemic Acquired Resistance (SAR), decomposition of plant material in soil to increase useful soil organic matter, and synthesis of phytohormones such as indole-acetic acid (IAA), acetoin and 2,3-butanediol that stimulate plant growth, development and responses to environmental stresses such as drought. In addition, these microorganisms can interfere with a plant's ethylene stress response by breaking down the precursor molecule, 1-aminocyclopropane-1-carboxylate (ACC), thereby stimulating plant growth and slowing fruit ripening. These beneficial microorganisms can improve soil quality, plant growth, yield, and quality of crops. Various microorganisms exhibit biological activity such as to be useful to control plant diseases. Such biopesticides (living organisms and the compounds naturally produced by these organisms) can be safer and more biodegradable than synthetic fertilizers and pesticides.

Fungal phytopathogens, including but not limited to Botrytis spp. (e.g. Botrytis cinerea), Fusarium spp. (e.g. F. oxysporum and F. graminearum), Rhizoctonia spp. (e.g. R. solani), Magnaporthe spp., Mycosphaerella spp., Puccinia spp. (e.g. P. recondita), Phytopthora spp. and Phakopsora spp. (e.g. P. pachyrhizi), are one type of plant pest that can cause servere economic losses in the agricultural and horticultural industries. Chemical agents can be used to control fungal phytopathogens, but the use of chemical agents suffers from disadvantages including high cost, lack of efficacy, emergence of resistant strains of the fungi, and undesireable environmental impacts. In addition, such chemical treatments tend to be indiscriminant and may adversely affect beneficial bacteria, fungi, and arthropods in addition to the plant pathogen at which the treatments are targeted. A second type of plant pest are bacterial pathogens, including but not limited to Erwinia spp. (such as Erwinia chrysanthemi), Pantoea spp. (such as P. citrea), Xanthomonas (e.g. Xanthomonas campestris), Pseudomonas spp. (such as P. syringae) and Ralstonia spp. (such as R. soleacearum) that cause servere economic losses in the agricultural and horticultural industries. Similar to pathogenic fungi, the use of chemical agents to treat these bacterial pathogens suffers from disadvantages. Viruses and virus-like organisms comprise a third type of plant disease-causing agent that is hard to control, but to which bacterial microorganisms can provide resistance in plants via induced systemic resistance (ISR). Thus, microorganisms that can be applied as biofertilizer and/or biopesticide to control pathogenic fungi, viruses, and bacteria are desirable and in high demand to improve agricultural sustainability. A final type of plant pathogen includes plant pathogenic nematodes and insects, which can cause severe damage and loss of plants.

Some members of the species Bacillus have been reported as biocontrol strains, and some have been applied in commercial products (Kloepper, et al. 2004, Phytopathology Vol. 94, No. 11, 2004 1259-1266). For example, strains currently being used in commercial biocontrol products include: Bacillus licheniformis strain QST2808, used as active ingredient in SONATA and BALLAD-PLUS, produced by BAYER CROP SCIENCE; Bacillus licheniformis strain GB34, used as active ingredient in YIELDSHIELD, produced by BAYER CROP SCIENCE; Bacillus subtilis strain QST713, used as the active ingredient of SERENADE, produced by BAYER CROP SCIENCE; Bacillus subtilis strain GBO3, used as the active ingredient in KODIAK and SYSTEM3, produced by HELENA CHEMICAL COMPANY. Various strains of Bacillus thuringiensis and Bacillus firmus have been applied as biocontrol agents against nematodes and vector insects and these strains serve as the basis of numerous commercially available biocontrol products, including NORTICA and PONCHO-VOTIVO, produced by BAYER CROP SCIENCE. In addition, Bacillus strains currently being used in commercial biostimulant products include: Bacillus amyloliquefaciens strain FZB42 used as the active ingredient in RHIZOVITAL 42, produced by ABiTEP GmbH, as well as various other Bacillus subtilus species that are included as whole cells including their fermentation extract in biostimulant products, such as FULZYME produced by JHBiotech Inc.

The presently disclosed subject matter provides soil compositions enhanced with Bacillus spp. microorganisms for benefiting plant growth.

### SUMMARY OF THE INVENTION

In one embodiment of the present invention, a planting matrix is provided for benefiting plant growth, the planting matrix comprising a biologically pure culture of a strain of Bacillus licheniformis, present in an amount suitable to benefit plant growth.

In one embodiment of the present invention, a planting matrix is provided for benefiting plant growth, the planting matrix including a biologically pure culture of Bacillus licheniformis RTI184 deposited as ATCC No. PTA-121722, or a mutant thereof having all the identifying characteristics thereof, present in an amount suitable to benefit plant growth.

In one embodiment of the present invention, a planting matrix is provided for benefiting plant growth, the planting matrix comprising a biologically pure culture of Bacillus licheniformis CH200 deposited as Accession No. DSM 17236, or a mutant thereof having all the identifying characteristics thereof, present in an amount suitable to benefit plant growth.

### BRIEF DESCRIPTION OF THE DRAWINGS

FIG. 1 shows images showing the positive effects on tomato growth as a result of addition of Bacillus licheniformis CH200 spores to SCOTTS MIRACLE-GRO (SCOTTS MIRACLE GRO, Co; Marysville, Ohio) potting mix at a pH of 5.5 according to one or more embodiments of the present invention. A) Plants grown in soil with added Bacillus licheniformis CH200 spores at 1×10⁷ spores/g soil. B) Control plants grown in the same soil without added Bacillus licheniformis CH200.

FIG. 2 shows images showing the positive effects on tomato growth as a result of addition of Bacillus licheniformis RTI184 spores to SCOTTS MIRACLE-GRO (SCOTTS MIRACLE GRO, Co; Marysville, Ohio) potting mix at a pH of 5.5 according to one or more embodiments of the present invention. A) Plants grown in soil with added Bacillus licheniformis RTI184 spores at 1×10⁷ spores/g soil. B) Control plants grown in the same soil without added Bacillus licheniformis RTI184.

FIG. 3 shows images showing the positive effects on cucumber growth in SCOTTS MIRACLE-GRO (SCOTTS MIRACLE GRO, Co; Marysville, Ohio) potting mix at pH 5.5 after addition of Bacillus licheniformis RTI184 spores or CH200 spores to the soil according to one or more embodiments of the present invention. A) Control plants grown in soil without addition of Bacillus spp. spores; B) Plants grown in soil with addition of 1×10⁷ spores/g soil Bacillus licheniformis RTI184 spores; C) Control plants grown in soil without addition of Bacillus spp. spores; and D) Plants grown in soil with addition of 1×10⁷ spores/g soil Bacillus licheniformis CH200 spores.

FIG. 4 shows images showing the positive effects on growth and vigor in cucumber as a result of addition of Bacillus licheniformis strain RTI184 to PRO-MIX BX (PREMIER TECH, INC; Quebec, Canada) potting soil limed to pH of 6.5 according to one or more embodiments of the present invention. A) Control cucumber plants without addition of Bacillus licheniformis RTI184 spores to the soil; and B) Cucumber plants after addition to soil of 1×10⁷ CFU/g soil Bacillus licheniformis RTI184 spores.

FIG. 5 shows images showing the positive effects on growth and vigor in tomato as a result of addition of Bacillus licheniformis strain RTI184 to PRO-MIX BX (PREMIER TECH, INC; Quebec, Canada) potting soil limed to pH of 6.5 according to one or more embodiments of the present invention. A) Tomato plants after addition to soil of 1×10⁷ CFU/g soil Bacillus licheniformis RTI184 spores; and B) Control tomato plants in the same soil without addition of Bacillus licheniformis RTI184.

FIG. 6 shows images showing the positive effects on growth and vigor in pepper as a result of addition of Bacillus licheniformis strain RTI184 to PRO-MIX BX (PREMIER TECH, INC; Quebec, Canada) potting soil limed to pH of 6.5 according to one or more embodiments of the present invention. A) Pepper plants after addition to soil of 1×10⁷ CFU/g soil Bacillus licheniformis RTI184 spores; and B) Control pepper plants in the same soil without addition of Bacillus licheniformis RTI184.

FIG. 7 is a schematic diagram showing both previously reported Fengycin-type and Dehydroxyfengycin-type cyclic lipopeptides produced by microbial species including Bacillus licheniformis and newly identified (shown in bold type) Fengycin- and Dehydroxyfengycin-type molecules produced by the Bacillus licheniformis RTI184 isolate according to one or more embodiments of the present invention.

FIG. 8 is an image of agarose gel electrophoresis of BOX-PCR fingerprinting patterns for genomic DNA of Bacillus licheniformis strains CH200, RTI1242, RTI1249, RTI184, RTI1243, RTI1112, FCC1598, and RTI239, RTI241, and RTI253 according to one or more embodiments of the present invention. The 1 kb DNA ladder (FERMENTAS) was used as molecular size marker. Based on the BOX-PCR patterns, the ten strains fall into three main groups, Group 1, Group 2A-2B, and Group 3 (Group 2A and 2B represent the position on the gel).

### DETAILED DESCRIPTION OF THE INVENTION

The terms “a,” “an,” and “the” refer to “one or more” when used in this application, including the claims. Thus, for example, reference to “a plant” includes a plurality of plants, unless the context clearly is to the contrary, and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and claims, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

A plant-associated bacterium, identified as belonging to the species Bacillus licheniformis, was isolated from the root of rice grown in California and subsequently tested for plant growth promoting properties. More specifically, the isolated bacterial strain was identified as being a new strain of Bacillus licheniformis through sequence analysis of highly conserved 16S rRNA and rpoB genes (see EXAMPLE 1). The 16S RNA sequence of the new bacterial isolate (designated “RTI184”) was determined to be nearly identical to the 16S rRNA gene sequence of two other known strains of B. licheniformis, Bacillus licheniformis strain 9945A (99%, 2 bp difference over 1545 bp in one copy of the 16S rRNA gene out of three different copies) and Bacillus licheniformis ATCC 14580 (99%, 8 bp difference over 1545 bp). In addition, it was determined that the rpoB sequence of RTI184 has 100% sequence identity to known strain Bacillus licheniformis 9945A (CP005965) and 97% sequence identity to Bacillus licheniformis strain deposited as ATCC 14580 (97 bp difference over 3015 bp). To further discriminate between strain RTI184 and Bacillus licheniformis 9945A, the genome sequences for their pathways involved in biosynthesis of lichenysin, the characteristic anionic cyclic lipoheptapeptide biosurfactant produced by Bacillus licheniformis species, were compared. Although similar, some differences were observed between the lichA and lichB genes for strains RTI184 and 9945A. Thus, the RTI184 strain was identified as a unique strain of Bacillus licheniformis. The strain of B. licheniformis RTI184 was deposited on 13 Nov. 2014 under the terms of the Budapest Treaty on the International Recognition of the Deposit of Microorganisms for the Purposes of Patent Procedure at the American Type Culture Collection (ATCC) in Manassas, Va., USA and bears the Patent Accession No. PTA-121722. In one embodiment, a Bacillus licheniformis strain CH200 is provided for use in the compositions of the present invention. The Bacillus licheniformis strain CH200 has been deposited on Apr. 7, 2005 at Deutsche Sammlung von Mikroorganismen and Zellkulturen GmbH, Mascheroder Weg 1 b, D-38124 Braunschweig (DSMZ) and assigned the Accession No. DSM 17236.

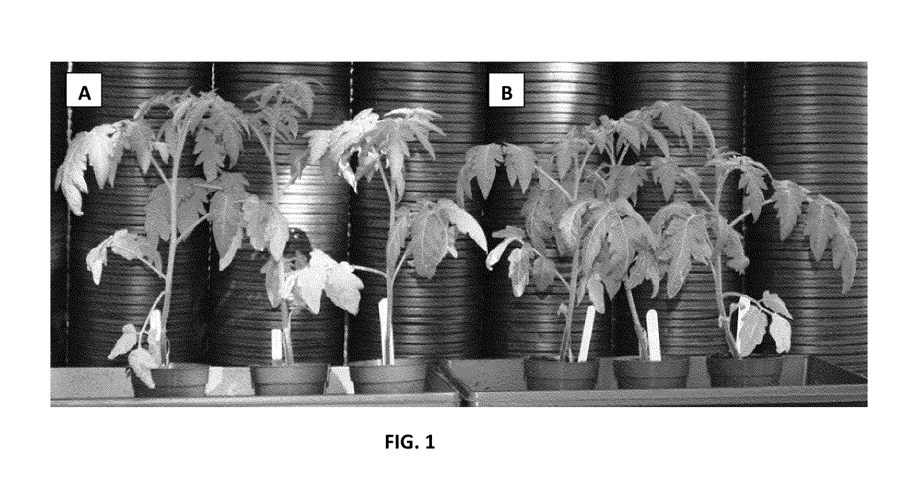

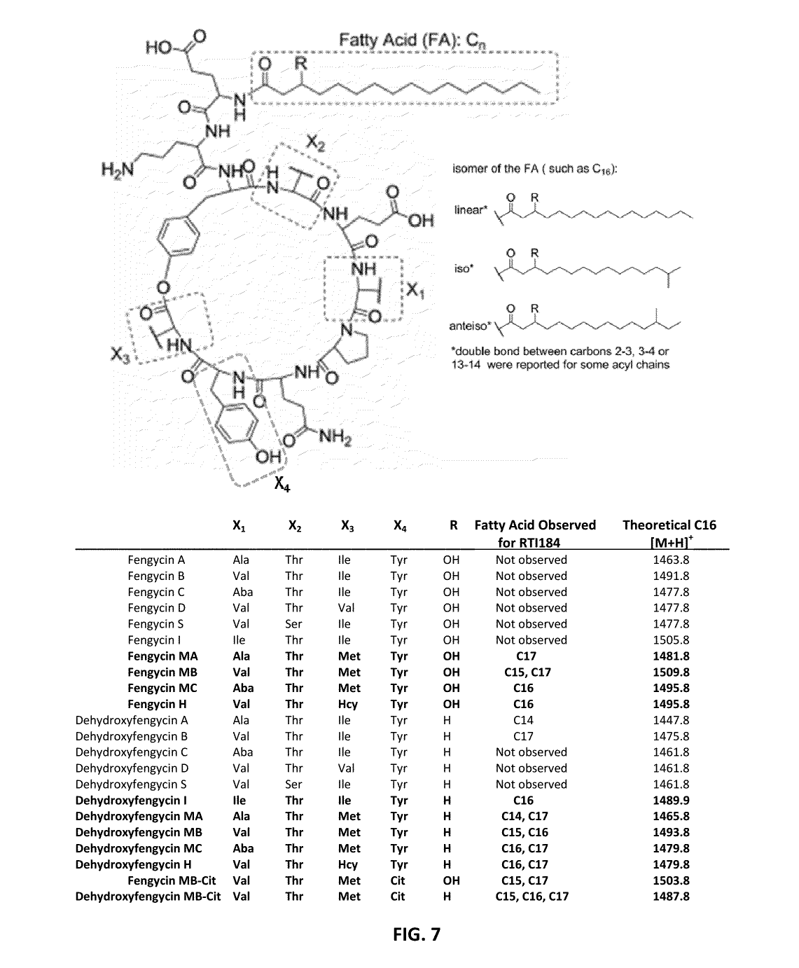

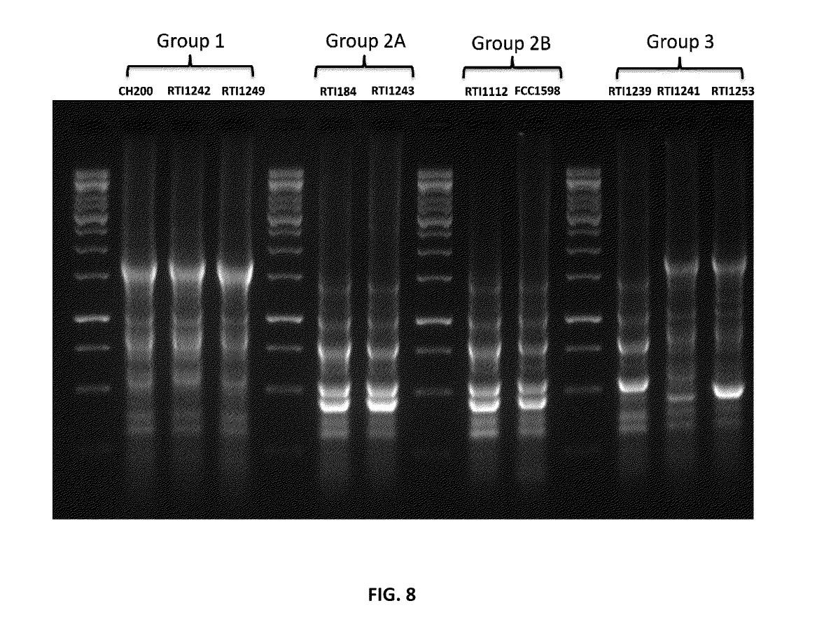

Experiments were performed that showed substantial growth promoting activity of the Bacillus licheniformis RTI184 and CH200 strains on various plants when grown in different planting matrices augmented with spores of each of the RTI184 and CH200 strains. The experimental results are provided in FIGS. 1-6 and in EXAMPLES 2-4 herein below. In addition, experiments were performed to investigate the types of cyclic lipopeptides (i.e., cyclic peptide molecules that contain a fatty acid group known as Fengycins and Dehydroxyfengycins) that are produced by the Bacillus licheniformis strains RTI184 and CH200. The experimental results for the Bacillus licheniformis strains are provided in FIGS. 7-8 and in EXAMPLE 5 herein below. Surprisingly, the investigations of the cyclic lipopeptides resulted in the discovery that the RTI184 and CH200 strains produce 4 classes of previously unreported Fengycin- and Dehydroxyfengycin-type molecules. The new classes are designated as: 1) Fengycin H and Dehydroxyfengycin H; 2) Dehydroxyfengycin I; 3) Fengycin MA/MB/MC and Dehydroxyfengycin MA/MB/MC; and 4) Fengycin MB-Cit and Dehydroxyfengycin MB-Cit, the details of which are described in EXAMPLE 5 and shown in FIG. 7.

In addition to the discovery of the new classes of cyclic lipopeptides produced by the RTI184 and CH200 strains, experiments revealed that synthesis of these previously unreported types of Fengycin- and Dehydroxyfengycin-type metabolites is strain dependent rather than intrinsic to the species Bacillus licheniformis. For example, even closely related Bacillus licheniformis strains produced different Fengycin- and Dehydroxyfengycin-type molecules and one closely related Bacillus licheniformis strain failed to produce any Fengycin- or Dehydroxyfengycin-type metabolites at all (see EXAMPLE 5 and FIG. 8). Thus, the newly discovered Bacillus licheniformis RTI184 strain and the CH200 strain possess unique properties for benefiting plant growth and health not uniformly exhibited among Bacillus licheniformis strains.

The phenotypic traits such as phytohormone production, acetoin and indole acetic acid (IAA), and nutrient cycling of the RTI184 strain are described in EXAMPLE 2.

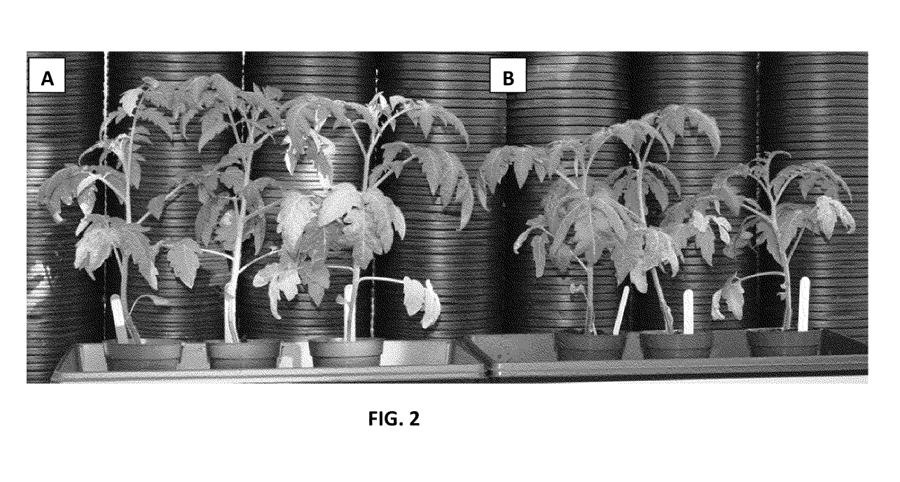

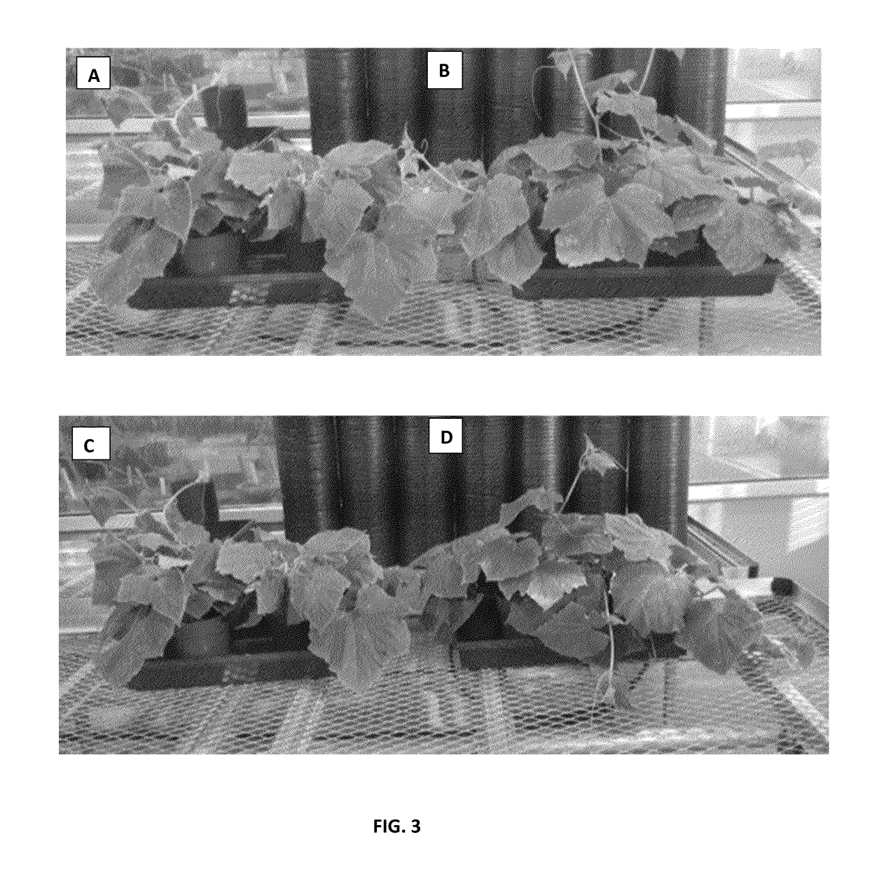

The effect of the presence of spores of the bacterial isolates RTI184 and CH200 when present in potting soil on growth and vigor for cucumber and tomato is described in EXAMPLE 3. In this experiment, cucumber and tomato seeds were planted in SCOTTS MIRACLE GROW (SCOTTS MIRACLE GRO, Co; Marysville, Ohio) potting mix pH˜5.5 tossed with either 1×10⁷ spores/g Bacillus licheniformis strain RTI184 or 1×10⁷ spores/g Bacillus licheniformis strain CH200 as compared to unaugmented soil. Images of the tomato plants at week 5 are shown in FIGS. 1-2 and of the cucumber plants in FIG. 3. Visual inspection of both the tomato and cucumber plants showed enhanced growth and increased biomass for all the plants grown in the SCOTTS MIRACLE GRO potting mix with either added Bacillus licheniformis RTI184 or CH200 over the unaltered SCOTTS MIRACLE GRO potting mix. The increased size of the plants treated with the RTI184 or the CH200 strain relative to the control plants demonstrates the positive effect on growth provided by treatment with these strains.

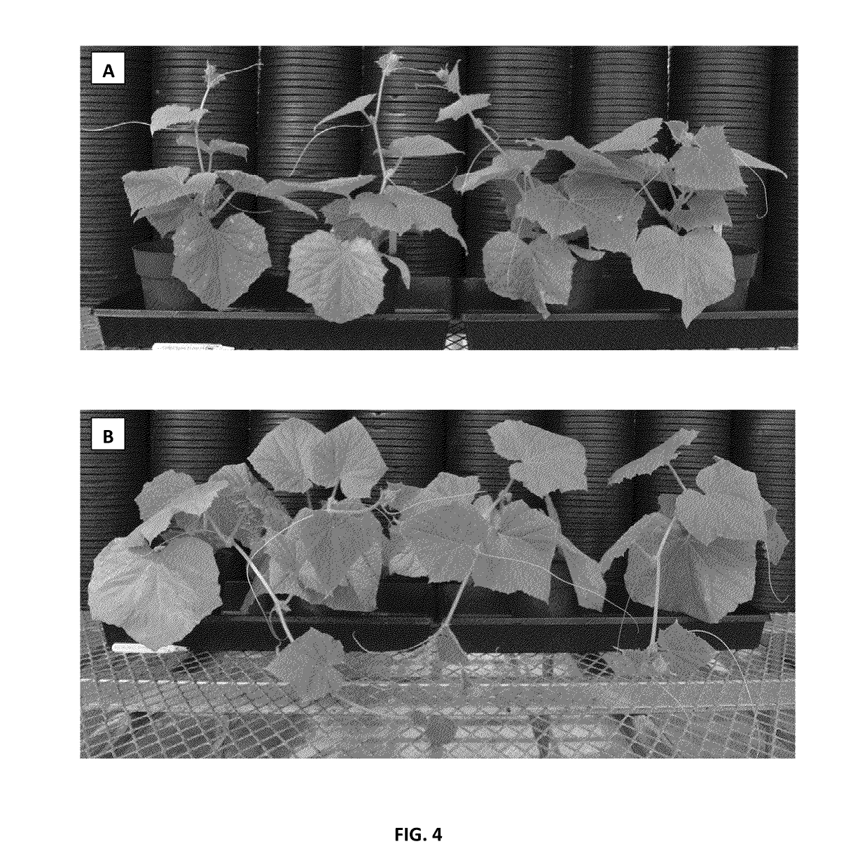

The effect of the presence of spores of the bacterial isolate RTI184 when present in potting soil on growth and vigor for cucumber, tomato, and pepper is similarly described in EXAMPLE 4 for a different potting soil. In this experiment, cucumber, tomato, and pepper seeds were planted in PRO-MIX BX (PREMIER TECH, INC; Quebec, Canada) potting soil, limed to a pH of 6.5, and augmented with 1×10⁷ spores/g soil Bacillus licheniformis strain RTI184. Plants were imaged and harvested and their dry shoot weight was measured and compared to data obtained for unaugmented control plants. The positive effects of the RTI184-augmented soil on growth are shown in FIGS. 4-6 and in Table II. The images in FIGS. 4-6 shown that the plants grown in the RTI184-augmented potting soil were substantially larger than the control plants for all crop types, demonstrating the positive effect of the RTI184 strain on plant growth. The increase in dry shoot mass observed for the cucumber, tomato, and pepper plants grown in the RTI184-augmented soil over control was 44%, 68%, and 26%, respectively (Table II).

EXAMPLE 5 describes the investigation of the cyclic lipopeptides, Fengycins and Dehydroxyfengycins, produced by the Bacillus licheniformis RTI184 and CH200 strains, and surprisingly, the identification of 4 previously unreported classes of these molecules. FIG. 7 is a schematic diagram showing both previously reported Fengycin-type and Dehydroxyfengycin-type cyclic lipopeptides produced by microbial species including Bacillus licheniformis and the previously unreported Fengycin- and Dehydroxyfengycin-type molecules produced by the newly identified Bacillus licheniformis RTI184 isolate (shown in bold type). A summary of the previously reported Fengycin- and Dehydroxyfengycin-type lipopeptides and the newly identified metabolites produced by both the RTI184 and CH200 strains are provided in Tables III and IV.

For the first new class, it was determined that the RTI184 strain produces previously unidentified derivatives of these compounds where the L-isoleucine at position 8 of the cyclic peptide chain (referred to as X₃ in FIG. 7) is replaced by L-methionine. This new class of Fengycin and Dehydroxyfengycin is referred to herein as MA, MB and MC, referring to derivatives of classes A, B and C in which the L-isoleucine at X₃ in FIG. 7 has been replaced by L-methionine. The newly identified molecules are shown in bold in FIG. 7 and in Table III. In addition, another previously unidentified class of these molecules produced by the Bacillus licheniformis strain RTI184 was identified, in which the Tyrosine (Tyr) of Fengycin MB and Dehydroxyfengycin MB (position X₄ in FIG. 7) is replaced by the α-amino acid, Citruline. This new class of Fengycin and Dehydroxyfengycin is being referred to herein as Fengycin MB-Cit and Dehydroxyfengycin MB-Cit and is shown in bold in FIG. 7 and in Table III. It was further determined that the Bacillus licheniformis strain RTI184 produces an additional class of Fengycin and Dehydroxyfengycin that has not been previously identified. In this class, the L-isoleucine of Fengycin B and Dehydroxyfengycin B (position X₃ in FIG. 7) is replaced by L-homo-cysteine (Hcy). These previously unidentified Fengycin and Dehydroxyfengycin metabolites are referred to herein as Fengycin H and Dehydroxyfengycin H and are shown in bold in FIG. 7 and in Table III. It was further determined that the Bacillus licheniformis strain RTI184 produces an additional class of Dehydroxyfengycin that has not been previously identified. In this class, position X₁ in FIG. 7 is replaced by L-isoleucine. This previously unidentified Dehydroxyfengycin metabolite is referred to herein as Dehydroxyfengycin I and is shown in bold in FIG. 7 and in Table III.

In addition to the discovery of the new classes of cyclic lipopeptides produced by the RTI184 strain, further experiments described in EXAMPLE 5 revealed that synthesis of these new types of Fengycin- and Dehydroxyfengycin-type metabolites is strain dependent rather than intrinsic to the species Bacillus licheniformis. For these experiments, the synthesis of cyclic lipopeptides was compared between ten Bacillus licheniformis strains. The ten bacterial strains selected for this analysis were identified as being Bacillus licheniformis strains based on sequence comparison of their highly conserved 16S rRNA and rpoB gene sequences. The genomic DNA of each strain was isolated and compared by BOX-PCR pattern and an image of the gel showing the resulting BOX-PCR patterns for the strains is shown in FIG. 8. Specifically, FIG. 8 shows agarose gel electrophoresis of BOX-PCR fingerprinting patterns for genomic DNA of Bacillus licheniformis strains CH200, RTI1242, RTI1249, RTI184, RTI1243, RTI1112, FCC1598, and RTI239, RTI241, and RTI253. Based on their BOX-PCR pattern, the ten strains fell into three main groups, Group 1, Group 2A-2B (Group 2A and 2B represent the position on the gel in FIG. 8), and Group 3, which comprises the strains not belonging to Groups 1 or 2.

To determine the type of Fengycin- and Dehydroxyfengycin-type metabolites produced by each of the ten Bacillus licheniformis strains, the strains were analyzed using UHPLC-TOF MS. In addition, the Lichenysin-type metabolites, characteristic for Bacillus licheniformis, were also analyzed as internal controls. The results of the UHPLC-TOF MS analysis are summarized in Table IV in EXAMPLE 5. The lichenysin and fengycin-type and dehyroxyfengycin-type molecules, their lipid modification (fatty acid (FA) chain length), predicted molecular mass, and their presence or absence in the culture supernatant of each of the ten Bacillus licheniformis strains are presented in Table IV. The data show that the Lichenysin-type metabolites were synthesized by all ten strains, confirming that they are Bacillus licheniformis strains. On the other hand, major differences were observed between the ten strains with regard to the production of the Fengycin- and Dehydroxyfengycin-type metabolites. Strains RTI184 and RTI1112 (Group 2), which had identical BOX-PCR patterns, were found to produce the same type of Fengycin- and Dehydroxyfengycin-type metabolites, including dehydroxy Fengycin A/B/C/D/I/S, Dehydroxyfengycin H/MA/MB/MC, dehydroxyfengycin MB-Cit, Fengycin H/MA/MB/MC and Fengycin MB-Cit, but failed to produce the Fengycin A/B/C/D/I/S type metabolites. On the other hand, strain FCC1598 which also falls into Group 2, produced the Fengycin A/B/C/D/I/S type metabolites, but failed to produce the Fengycin H/MA/MB/MC-type metabolites. Surprisingly, strain RTI1243, which also belongs to Group 2, did not produce any of the Fengycin- and Dehydroxyfengycin-type metabolites. Finally, two of the strains belonging to Group 1 (RTI1242 and RTI1249) and two strains belonging to Group 3 (RTI1241 and RTI1253) failed to produce any of the Fengycin- and Dehydroxyfengycin-type metabolites, whereas the CH200 and RTI1239, belonging to Group 1 and Group 3, respectively, produced all of the Fengycin- and Dehydroxyfengycin-type metabolites. Based on these results, it was concluded that the synthesis of the different types of Fengycin- and Dehydroxyfengycin-type metabolites, including the newly identified citruline-containing metabolites, is strain dependent rather than intrinsic to the species Bacillus licheniformis. For example, even closely related Bacillus licheniformis Group 2 strains produced different Fengycin- and Dehydroxyfengycin-type molecules and one closely related Group 2 strain failed to produce any Fengycin- or Dehydroxyfengycin-type metabolites at all. Thus, the newly discovered Bacillus licheniformis RTI184 strain and the CH200 strain can possess unique properties for benefiting plant growth and health not uniformly exhibited among Bacillus licheniformis strains.

In one embodiment of the invention, a planting matrix is provided for benefiting plant growth, the planting matrix including a biologically pure culture of a Bacillus licheniformis strain, present in an amount suitable to benefit plant growth. Spores of the Bacillus licheniformis can be present in the matrix in an amount suitable to benefit plant growth. The growth benefit of the plant can be exhibited by one or a combination of improved seedling vigor, improved root development, improved plant growth, improved plant health, increased yield, and improved appearance. In one embodiment of the invention, a planting matrix is provided for benefiting plant growth, the planting matrix including a biologically pure culture of Bacillus licheniformis RTI184 deposited as ATCC No. PTA-121722, or a mutant thereof having all the identifying characteristics thereof, present in an amount suitable to benefit plant growth.

In one embodiment of the invention, a planting matrix is provided for benefiting plant growth, the planting matrix comprising a biologically pure culture of Bacillus licheniformis CH200 deposited as Accession No. DSM 17236, or a mutant thereof having all the identifying characteristics thereof, present in an amount suitable to benefit plant growth.

The phrase “a biologically pure culture of a Bacillus licheniformis CH200” refers to one or a combination of: spores of the biologically pure fermentation culture of a bacterial strain, vegetative cells of the biologically pure fermentation culture of a bacterial strain, one or more products of the biologically pure fermentation culture of a bacterial strain, a culture solid of the biologically pure fermentation culture of a bacterial strain, a culture supernatant of the biologically pure fermentation culture of a bacterial strain, an extract of the biologically pure fermentation culture of the bacterial strain, and one or more metabolites of the biologically pure fermentation culture of a bacterial strain.

The planting matrix is a plant growth medium and may be a soil substitute or soil enhancer. The planting matrix can be in the form of a potting soil. Potting soil, also known as potting mix or potting compost, is a plant growth medium used as a growing medium for plants in containers. Potting soil contains an organic component such as peat moss, for example sphagnum peat moss, and/or coir, and may further contain compost, processed forest products, perlite, vermiculite, a wetting agent, and a pH adjuster such as limestone.

The growth benefit of the plant can be exhibited by one or a combination of improved seedling vigor, improved root development, improved plant growth, improved plant health, increased yield, and improved appearance.

The plant can include, but is not limited to, wherein the plant comprises Berry, Blueberry, Blackberry, Raspberry, Loganberry, Huckleberry, Cranberry, Gooseberry, Elderberry, Currant, Caneberry, Bushberry, Strawberry, Brassica Vegetables, Broccoli, Cabbage, Cauliflower, Brussels Sprouts, Collards, Kale, Mustard Greens, Kohlrabi, Cucurbit Vegetables, Cucumber, Cantaloupe, Melon, Muskmelon, Squash, Watermelon, Pumpkin, Eggplant, Bulb Vegetables, Onion, Garlic, Shallots, Fruiting Vegetables, Pepper, Tomato, Ground Cherry, Tomatillo, Okra, Grape, Herbs/Spices, Leafy Vegetables, Lettuce, Celery, Spinach, Parsley, Radicchio, Legumes/Vegetables (succulent and dried beans and peas), Sunflower, Root/Tuber and Corm Vegetables, Carrot, Potato, Sweet Potato, Cassave, Beets, Ginger, Horseradish, Radish, Ginseng, Turnip, Kiwi, Banana, herbs, Rosemary, Thyme, Cilantro, Oregano, Parsley, Sage, Mint, Lemon grass, Ornamental plants, Annuals, Poinsettia, Helichrysum, Geranium, Begonia, Bacopa, Chrysocephalum, Calibrachoa, Coleus, Cleome, Evolvulus, Angelonia, Argyranthemum, Nemesia, Osteospermum, Petunia, Pansiola, Pelargonium, Cyperus, Dalina, Dahlia, Dichondra, Ipomoea, Lantana, Lobularia, Lobelia, Euphorbia, Impatiens, Verbena, Scaevola, Sedum, Scirpus, Setaceum, Nemesia, Phlox, Torenia, Mecardonia, Perennials, Hydrangea, Clematis, Rosa, Buddleia, Salvia, Sedum, Sambucus, Hybiscus, Weigelia, Hardwood cuttings, Chestnuts, Oak, Maple, Stone Fruit, Apricot, Cherry, Nectarine, Peach, Plum, Prune, Citrus, Orange, Grapefruit, Lemon, Tangerine, Tangelo, Pummelo.

The planting matrix can be in the form of a potting soil. The pH of the planting matrix can range from about pH 4 to about pH 8, from about pH 5 to about pH 7, or from about pH 5.5 to pH 6.5.

In the planting matrices of the present invention, the Bacillus licheniformis RTI184 or Bacillus licheniformis CH200 can be in the form of spores. The Bacillus licheniformis RTI184 spores or the Bacillus licheniformis CH200 spores can be present in the planting matrix in an amount from about 1.0×10⁵ CFU/g to about 1.0×10⁹ CFU/g. The Bacillus licheniformis RTI184 spores or the Bacillus licheniformis CH200 spores can be present in an amount from about 1.0×10⁶ CFU/g to about 1.0×10⁹ CFU/g.

The planting matrix can further include one or more of a microbial or a chemical insecticide, fungicide, nematicide, or bacteriocide, present in an amount suitable to benefit plant growth or health. The planting matrix can further include one or both of a plant extract, a plant growth regulator, or a fertilizer present in an amount suitable to benefit plant growth or health.

### EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter.

### Example 1

### Identification of a Bacterial Isolate as a Bacillus Licheniformis Through Sequence Analysis

A plant associated bacterial strain, designated herein as RTI184, was isolated from the root of rice grown in California. The 16S rRNA and the rpoB genes of the RTI184 strain were sequenced and subsequently compared to other known bacterial strains in the NCBI and RDP databases using BLAST. It was determined that the 16S RNA partial sequence of RTI184 (SEQ ID NO: 1) is nearly identical to the 16S rRNA gene sequence of two other known strains of B. licheniformis, Bacillus licheniformis strain 9945A (99%, 2 bp difference over 1545 bp in one copy of the 16S rRNA gene out of three different copies) and Bacillus licheniformis ATCC 14580 (99%, 8 bp difference over 1545 bp). In addition, it was determined that the rpoB sequence of RTI184 (SEQ ID NO: 2) has 100% sequence identity to known strain Bacillus licheniformis 9945A (CP005965) and 97% sequence identity to Bacillus licheniformis strain deposited as ATCC 14580 (97 bp difference over 3015 bp). To further discriminate between strain RTI184 and Bacillus licheniformis 9945A, the genome sequences for their pathways involved in biosynthesis of lichenysin, the characteristic anionic cyclic lipoheptapeptide biosurfactant produced by Bacillus licheniformis species, were compared. Although very similar, minor differences were observed between the lichA and lichB genes for strains RTI184 and 9945A. Thus, the RTI184 strain was identified as a unique strain of Bacillus licheniformis.

### Example 2

### Phenotypic Traits of Bacillus Licheniformis RTI184 Isolate

In addition to the antagonistic properties, various phenotypic traits were also measured for the Bacillus licheniformis RTI184 strain and the data are shown below in Table I. The assays were performed according to the procedures described in the text below Table I.

TABLE I
Phenotypic Assays: phytohormone production,
acetoin and indole acetic acid (IAA), and
nutrient cycling of Bacillus licheniformis RTI184 isolate.

| Characteristic Assays | RTI184 |
|---|---|
| Acid production (Methyl Red) | − |
| Acetoin production (MR-VP) | +++ |
| Chitinase activity | + |
| Indole-3-Acetic Acid production | − |
| Protease activity | + |
| Phosphate solubilization | − |
| Phenotype | hard dry texture white/cream |

+++ very strong,
++ strong,
+ some,
+− weak,
− none observed

Acid and Acetoin Test.

20 μl of a starter culture in rich 869 media was transferred to 1 ml Methy Red—Voges Proskauer media (Sigma Aldrich 39484). Cultures were incubated for 2 days at 30° C. 200 rpm. 0.5 ml culture was transferred and 50 μl 0.2 g/l methyl red was added. Red color indicated acid production. The remaining 0.5 ml culture was mixed with 0.3 ml 5% alpha-napthol (Sigma Aldrich N1000) followed by 0.1 ml 40% KOH. Samples were interpreted after 30 minutes of incubation. Development of a red color indicated acetoin production. For both acid and acetoin tests non-inoculated media was used as a negative control (Isenberg, H. D. (ed.) 2004, Clinical microbiology procedures handbook, vol. 1, 2 and 3, 2nd ed. American Society for Microbiology, Washington, D.C.).

Indole-3—Acetic Acid.

20 μl of a starter culture in rich 869 media was transferred to 1 ml 1/10 869 Media supplemented with 0.5 g/l tryptophan (Sigma Aldrich T0254). Cultures were incubated for 4-5 days in the dark at 30° C., 200 RPM. Samples were centrifuged and 0.1 ml supernatant was mixed with 0.2 ml Salkowski's Reagent (35% perchloric acid, 10 mM FeCl3). After incubating for 30 minutes in the dark, samples resulting in pink color were recorded positive for IAA synthesis. Dilutions of IAA (Sigma Aldrich I5148) were used as a positive comparison; non inoculated media was used as negative control (Taghavi et al., 2009, Applied and Environmental Microbiology 75: 748-757).

Phosphate Solubilizing Test.

Bacteria were plated on Pikovskaya (PVK) agar medium consisting of 10 g glucose, 5 g calcium triphosphate, 0.2 g potassium chloride, 0.5 g ammonium sulfate, 0.2 g sodium chloride, 0.1 g magnesium sulfate heptahydrate, 0.5 g yeast extract, 2 mg manganese sulfate, 2 mg iron sulfate and 15 g agar per liter, pH7, autoclaved. Zones of clearing were indicative of phosphate solubilizing bacteria (Sharma et al., 2011, Journal of Microbiology and Biotechnology Research 1: 90-95).

Chitinase Activity.

10% wet weight colloidal chitin was added to modified PVK agar medium (10 g glucose, 0.2 g potassium chloride, 0.5 g ammonium sulfate, 0.2 g sodium chloride, 0.1 g magnesium sulfate heptahydrate, 0.5 g yeast extract, 2 mg manganese sulfate, 2 mg iron sulfate and 15 g agar per liter, pH7, autoclaved). Bacteria were plated on these chitin plates; zones of clearing indicated chitinase activity (N. K. S. Murthy & Bleakley, 2012, The Internet Journal of Microbiology. 10(2)).

Protease Activity.

Bacteria were plated on 869 agar medium supplemented with 10% milk. Clearing zones indicated the ability to break down proteins suggesting protease activity (Sokol et al., 1979, Journal of Clinical Microbiology. 9: 538-540).

### Example 3

### Growth Effects of Cucumber and Tomato when Grown in Potting Soil Enhanced with Spores of Bacillus Licheniformis RTI184 and CH200 Isolates

The ability of the isolated strains of Bacillus licheniformis RTI184 and Bacillus licheniformis CH200 to improve growth and health of tomato and cucumber was determined by planting seeds of each in potting soil to which the spores of each of the Bacillus licheniformis RTI184 and Bacillus licheniformis CH200 strains had been added.

The Bacillus licheniformis CH200 strain was deposited on Apr. 7, 2005 at Deutsche Sammlung von Mikroorganismen and Zellkulturen GmbH, Mascheroder Weg 1 b, D-38124 Braunschweig (DSMZ) and given the accession No. DSM 17236.

For the experiments using spores of RTI184 or CH200, the strains were each sporulated in 2XSG in a 14 L fermenter. Spores were collected but not washed afterwards at a concentration of at least 1.0×10⁷ to 10⁹ CFU/mL.

The effect of the presence of spores of the bacterial isolates RTI184 and CH200 when present in potting soil on growth and vigor for cucumber and tomato was determined. In this experiment, cucumber and tomato seeds were planted in SCOTTS MIRACLE-GRO (SCOTTS MIRACLE GRO, Co; Marysville, Ohio) potting mix tossed with either 1×10⁷ spores/g soil Bacillus licheniformis strain RTI184 or 1×10⁷ spores/g soil Bacillus licheniformis strain CH200. Specifically, the soil to which the RTI184 or CH200 spores had been added was SCOTTS MIRACLE-GRO soil (pH˜5.5). Tomato was tested in 4″ pots and cucumber was tested in 6″ pots. One seed was planted per pot and there were 8 replicates per treatment. Images of the tomato plants at week 5 are shown in FIGS. 1-2 and of the cucumber plants in FIG. 3. Visual inspection of both the tomato and cucumber plants showed enhanced growth and increased biomass for all the plants grown in the SCOTTS MIRACLE-GRO potting mix with either added Bacillus licheniformis RTI184 or CH200 over the unaltered SCOTTS MIRACLE-GRO potting mix. Specifically FIGS. 1A-1B are images showing the positive effects on tomato growth as a result of addition of Bacillus licheniformis CH200 spores to SCOTTS MIRACLE-GRO potting mix at a pH of 5.5. A) Plants grown in soil with added Bacillus licheniformis CH200 spores at 1×10⁷ spores/g soil. B) Control plants grown in the same soil without added Bacillus licheniformis CH200. FIGS. 2A-2B are images showing the positive effects on tomato growth as a result of addition of Bacillus licheniformis RTI184 spores to SCOTTS MIRACLE-GRO (SCOTTS MIRACLE GRO, Co; Marysville, Ohio) potting mix at a pH of 5.5 according to one or more embodiments of the present invention. A) Plants grown in soil with added Bacillus licheniformis RTI184 spores at 1×10⁷ spores/g soil. B) Control plants grown in the same soil without added Bacillus licheniformis RTI184 soil. FIGS. 3A-3D are images showing the positive effects on cucumber growth in SCOTTS MIRACLE-GRO (SCOTTS MIRACLE GRO, Co; Marysville, Ohio) potting mix at pH 5.5 after addition of Bacillus licheniformis RTI184 spores or CH200 spores to the soil. A) Control plants grown in soil without addition of Bacillus spp. spores; B) Plants grown in soil with addition of 1×10⁷ spores/g soil Bacillus licheniformis RTI184 spores; C) Control plants grown in soil without addition of Bacillus spp. spores; and D) Plants grown in soil with addition of 1×10⁷ spores/g soil Bacillus licheniformis CH200 spores. The increased size of the plants treated with the RTI184 or the CH200 strain relative to the control plants demonstrates the positive effect on growth provided by treatment with these strains.

### Example 4

### Growth Effects of Bacillus Licheniformis Isolate RTI184 in Cucumber, Tomato, and Pepper

The effect of application of the bacterial isolate RTI184 on growth and vigor for cucumber, tomato, and pepper was determined. In this experiment, cucumber, tomato and pepper seeds were planted in PRO-MIX BX (PREMIER TECH, INC; Quebec, Canada) potting soil, limed to a pH of 6.5 and enhanced with 1×10⁷ spores/g soil Bacillus licheniformis strain RTI184. Seeds were planted in the RTI184-enhanced PROMIX BX soil in 6″ pots. One seed was planted per pot and there were 8 replicates per treatment. Plants were harvested and their dry shoot weight was measured and compared to data obtained for non-inoculated control plants. Dry shoot biomass was determined as a total weight per 8 plants. The data are shown below in Table II and in FIGS. 4-6 and demonstrate that plants grown in soil enhanced with RTI184 spores outperformed the control soil for all crop types.

Specifically, FIGS. 4A-4B are images of the cucumber data showing the positive effects on growth and vigor in cucumber after planting in the RTI184-enhanced soil: A) control cucumber plants; and B) cucumber plants grown in Bacillus licheniformis RTI184-enhanced soil. The images show that leaf size and overall plant size was significantly increased for the plants grown in the RTI184-enhanced soil relative to the control plants. The dry weight of shoot biomass (gram) for the plants grown in the RTI184-enhanced soil was increased 44% over that of the control plants (Table II).

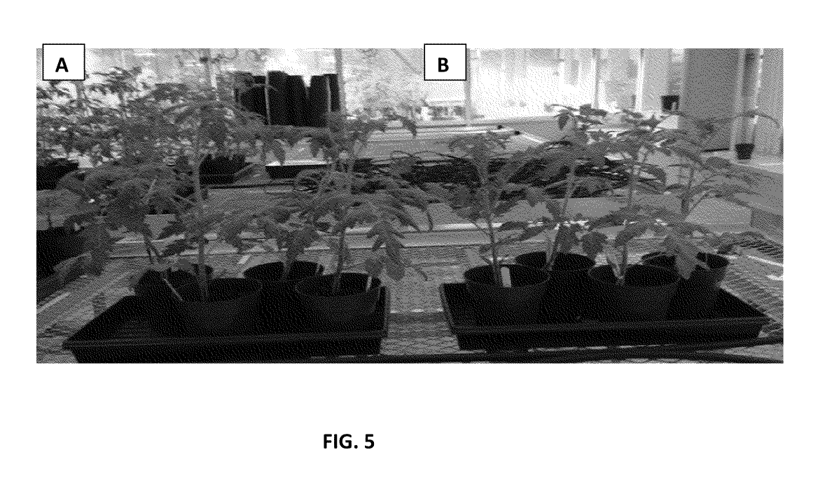

FIGS. 5A-5B are images of the tomato data showing the positive effects on growth and vigor in tomato after planting in the RTI184-enhanced soil: A) tomato plants grown in Bacillus licheniformis RTI184-enhanced soil; and B) control tomato plants. The images show that overall plant size was significantly increased for the plants grown in the RTI184-enhanced soil relative to the control plants. The dry weight of shoot biomass (gram) for the plants grown in the RTI184-enhanced soil was increased 68% over that of the control plants (Table II).

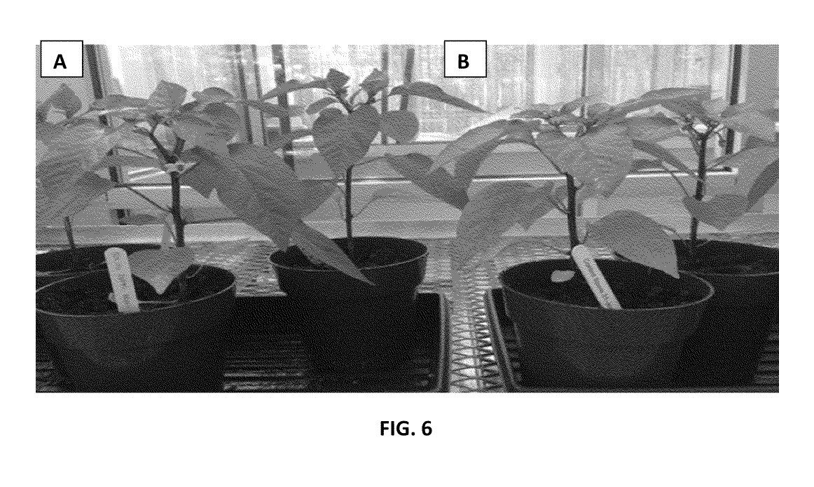

FIGS. 6A-6B are images of the pepper data showing the positive effects on growth and vigor in pepper after planting in the RTI184-enhanced soil: A) pepper plants grown in Bacillus licheniformis RTI184-enhanced soil; and B) control pepper plants. The images show that overall plant size was significantly increased for the plants grown in the RTI184-enhanced soil relative to the control plants. The dry weight of shoot biomass (gram) for the plants grown in the RTI184-enhanced soil was increased 26% over that of the control plants (Table II).

TABLE II
Effect on dry shoot mass in cucumber, tomato,
and pepper after growth in PROMIX BX
potting soil containing 1 × 10⁷ spores/g
soil Bacillus licheniformis strain RTI184.

| | Dry Weight of Shoot | % Increase |
|---|---|---|
| Crop | Biomass (gram) | Over Control |
| Cucumber-Control | 5.09 | |
| Cucumber | 7.33 | 44% |
| Tomato-Control | 5.55 | |
| Tomato | 9.32 | 68% |
| Pepper-Control | 2.20 | |
| Pepper | 2.77 | 26% |

### Example 5

### Identification of New Metabolites Produced by Bacillus Licheniformis RTI184 and CH200 Isolates

It has been previously reported that five classes of Fengycin-type metabolites and Dehydroxyfengycin-type metabolites are produced by microbial species including Bacillus licheniformis (Pecci, Y. et al., 2010; Li, Xing-Yu et al., 2013). These metabolites, belonging to the class of cyclic lipopeptides, are cyclic peptide molecules that also contain a fatty acid group. The five classes of Fengycin- and Dehydroxyfengycin-type metabolites are referred to as A, B, C, D and S. The backbone structure of these metabolites as well as the specific amino acid sequence for each of the five classes is shown in FIG. 7. The Fengycin- and Dehydroxyfengycin-type metabolites produced by Bacillus licheniformis strain RTI184 were analyzed using UHPLC-TOF MS. The molecular weights of the Fengycin-type metabolites produced by the RTI184 strain after both 3 and 6 days growth in rich media (either in 869 or in M2 medium) at 30° C. were compared to the theoretical molecular weights expected for the Fengycin- and Dehydroxyfengycin-type metabolites. In addition, to determine the amino acid composition of the various Fengycin-type metabolites produced by the RTI184 strain, peptide sequencing using LC-MS-MS was performed on each of the Fengycin-type metabolites previously identified via UHPLC-TOF MS. These data are shown in Table III below. In this manner, it was determined that Bacillus licheniformis strain RTI184 did not produce Fengycin A, B, C, D, or S.

Surprisingly, it was determined that the RTI184 strain produces previously unidentified derivatives of these compounds where the L-isoleucine at position 8 of the cyclic peptide chain (referred to as X₃ in FIG. 7) is replaced by L-methionine. The new classes of Fengycin and Dehydroxyfengycin are referred to herein as MA, MB and MC, referring to derivatives of classes A, B and C in which the L-isoleucine at X₃ in FIG. 7 has been replaced by L-methionine. The newly identified molecules are shown in bold in FIG. 7 and in Table III.

In addition to these new derivatives, another previously unidentified class produced by the Bacillus licheniformis strain RTI184 was identified, in which the Tyrosine (Tyr) of Fengycin MB and Dehydroxyfengycin MB (position X₄ in FIG. 7) is replaced by the α-amino acid, Citruline. This new class of Fengycin and Dehydroxyfengycin is being referred to herein as Fengycin MB-Cit and Dehydroxyfengycin MB-Cit and is shown in bold in FIG. 7 and in Table III.

It was further determined that the Bacillus licheniformis strain RTI184 produces an additional class of Fengycin and Dehydroxyfengycin that has not been previously identified. In this class, the L-isoleucine of Fengycin B and Dehydroxyfengycin B (position X₃ in FIG. 7) is replaced by L-homo-cysteine (Hcy). These previously unidentified Fengycin and Dehydroxyfengycin metabolites are referred to herein as Fengycin H and Dehydroxyfengycin H and are shown in bold in FIG. 7 and in Table III.

It was further determined that the Bacillus licheniformis strain RTI184 produces an additional class of Dehydroxyfengycin that has not been previously reported. In this class, position X₁ in FIG. 7 is replaced by L-isoleucine. This previously unreported Dehydroxyfengycin metabolite is referred to herein as Dehydroxyfengycin I and is shown in bold in FIG. 7 and in Table III.

A summary of the amino acid sequences for the previously reported Fengycin- and Dehydroxyfengycin-type lipopeptides and the newly identified metabolites (shown in bold) is provided in Table III below.

TABLE III
Summary of MS/MS identification of Fengycin-type metabolites in Bacillus licheniformis
RTI184 isolate.

| | | | | | | Ring | Theoretical C16 | Theoretical | Observed |
|---|---|---|---|---|---|---|---|---|---|
| Homolog | X₁ | X₂ | X₃ | X₄ | R | Mass | Molecular Formula | C16 [M + H]⁺ | RTI184 |
| Fengycin A | Ala | Thr | Ile | Tyr | OH | 1080.6 | C₇₂H₁₁₀N₁₂O₂₀ | 1463.8 | Not observed |
| Fengycin B | Val | Thr | Ile | Tyr | OH | 1108.7 | C₇₄H₁₁₄N₁₂O₂₀ | 1491.8 | Not observed |
| Fengycin C | Aba | Thr | Ile | Tyr | OH | 1094.6 | C₇₃H₁₁₂N₁₂O₂₀ | 1477.8 | Not observed |
| Fengycin D | Val | Thr | Val | Tyr | OH | 1094.6 | C₇₃H₁₁₂N₁₂O₂₀ | 1477.8 | Not observed |
| Fengycin S | Val | Ser | Ile | Tyr | OH | 1094.6 | C₇₃H₁₁₂N₁₂O₂₀ | 1477.8 | Not observed |
| Fengycin I | Ile | Thr | Ile | Tyr | OH | 1122.8 | C₇₇H₁₁₆N₁₂O₂₀ | 1505.8 | Not observed |
| Fengycin MA | Ala | Thr | Met | Tyr | OH | 1098.7 | C₇₁H₁₀₈N₁₂O₂₀S | 1481.8 | C17 |
| Fengycin MB | Val | Thr | Met | Tyr | OH | 1126.8 | C₇₃H₁₁₂N₁₂O₂₀S | 1509.8 | C15, C17 |
| Fengycin MC | Aba | Thr | Met | Tyr | OH | 1112.7 | C₇₂H₁₁₀N₁₂O₂₀S | 1495.8 | C16 |
| Fengycin H | Val | Thr | Hcy | Tyr | OH | 1112.7 | C₇₂H₁₁₀N₁₂O₂₀S | 1495.8 | C16 |
| Dehydroxyfengycin A | Ala | Thr | Ile | Tyr | H | 1080.6 | C₇₂H₁₁₀N₁₂O₁₉ | 1447.8 | C14 |
| Dehydroxyfengycin B | Val | Thr | Ile | Tyr | H | 1108.7 | C₇₄H₁₁₄N₁₂O₁₉ | 1475.8 | C17 |
| Dehydroxyfengycin C | Aba | Thr | Ile | Tyr | H | 1094.6 | C₇₃H₁₁₂N₁₂O₁₉ | 1461.8 | Not observed |
| Dehydroxyfengycin D | Val | Thr | Val | Tyr | H | 1094.6 | C₇₃H₁₁₂N₁₂O₁₉ | 1461.8 | Not observed |
| Dehydroxyfengycin S | Val | Ser | Ile | Tyr | H | 1094.6 | C₇₃H₁₁₂N₁₂O₁₉ | 1461.8 | Not observed |
| Dehydroxyfengycin I | Ile | Thr | Ile | Tyr | H | 1122.8 | C₇₅H₁₁₆N₁₂O₁₉ | 1489.9 | C16 |
| Dehydroxyfengycin MA | Ala | Thr | Met | Tyr | H | 1098.7 | C₇₁H₁₀₈N₁₂O₁₉S | 1465.8 | C14, C17 |
| Dehydroxyfengycin MB | Val | Thr | Met | Tyr | H | 1126.8 | C₇₃H₁₁₂N₁₂O₁₉S | 1493.8 | C15, C16 |
| Dehydroxyfengycin MC | Aba | Thr | Met | Tyr | H | 1112.7 | C₇₂H₁₁₀N₁₂O₁₉S | 1479.8 | C16, C17 |
| Dehydroxyfengycin H | Val | Thr | Hcy | Tyr | H | 1112.7 | C₇₂H₁₁₀N₁₂O₁₉S | 1479.8 | C16, C17 |
| Fengycin MB-Cit | Val | Thr | Met | Cit | OH | 1120.6 | C₇₀H₁₁₄N₁₄O₂₀S | 1503.8 | C15, C17 |
| Dehydroxyfengycin MB- | Val | Thr | Met | Cit | H | 1120.6 | C₇₀H₁₁₄N₁₄O₁₉S | 1487.8 | C15, C16, C17 |
| Cit | | | | | | | | | |

To determine whether the synthesis of the newly identified types of Fengycin- and Dehydroxyfengycin-type metabolites is intrinsic to the species Bacillus licheniformis or is instead specific to individual strains of Bacillus licheniformis, the synthesis of these types of molecules was compared between ten Bacillus licheniformis strains. The ten bacterial strains selected for this analysis were identified as being Bacillus licheniformis strains based on sequence comparison of their highly conserved 16S rRNA and rpoB gene sequences. The genomic DNA of each strain was isolated and compared by BOX-PCR pattern using a previously described method (Vinuesa, P. et al., 1998, Applied and Environmental Microbiology, 64, 2096-2104) and an image of the gel showing the resulting BOX-PCR patterns for the strains is shown in FIG. 8. Specifically, FIG. 8 shows agarose gel electrophoresis of BOX-PCR fingerprinting patterns for genomic DNA of Bacillus licheniformis strains CH200, RTI1242, RTI1249, RTI184, RTI1243, RTI1112, FCC1598, and RTI239, RTI241, and RTI253. As molecular size marker, the 1 kb DNA ladder (FERMENTAS) was used. Based on their BOX-PCR pattern, the ten strains fell into three main groups, Group 1, Group 2A-2B (Group 2A and 2B represent the position on the gel in FIG. 8), and Group 3.

To determine the type of Fengycin- and Dehydroxyfengycin-type metabolites produced by each of the ten Bacillus licheniformis strains, the strains were analyzed using UHPLC-TOF MS. In addition, the Lichenysin-type metabolites, characteristic for Bacillus licheniformis, were also analyzed as internal control. The results of the UHPLC-TOF MS analysis are summarized in Table IV below. The lichenysin and fengycin-type and dehyroxyfengycin-type molecules, their lipid modification (fatty acid (FA) chain length), predicted molecular mass, and their presence or absence in the culture supernatant of each of the ten Bacillus licheniformis strains grown for 6 days in M2 media are presented in Table IV. The data show that the Lichenysin-type metabolites were synthesized by all ten strains, confirming that they are true Bacillus licheniformis strains. On the other hand, major differences were observed between the ten strains with regard to the production of the Fengycin- and Dehydroxyfengycin-type metabolites.

TABLE IV
Summary of UHPLC-TOF MS identification of Fengycin-type and Dehydroxyfengycin-type
metabolites in 10 different Bacillus licheniformis isolates.

| | FA | | | | | |
|---|---|---|---|---|---|---|
| Compound | chain | [M + H]⁺ | CH200 | RTI1242 | RTI1249 | RTI184 |
| dehydroxy | C16-C18 | 1461.8239-1489.8552 | + | − | − | + |
| Fengycin | | | | | | |
| A/B/C/D/I/S | | | | | | |
| dehydroxy | C15-C17 | 1437.7334-1493.796 | + | − | − | + |
| Fengycin | | | | | | |
| H/MA/MB/ | | | | | | |
| MC | | | | | | |
| dehydroxyfengycin | C15-C17 | 1473.8021-1501.8334 | + | − | − | + |
| MB- | | | | | | |
| Cit | | | | | | |
| Fengycin | C15-C17 | 1477.8188-1491.8344 | + | − | − | − |
| A/B/C/D/I/S | | | | | | |
| Fengycin | C14-C17 | 1481.7596-1495.7752 | + | − | − | + |
| H/MA/MB/ | | | | | | |
| MC | | | | | | |
| Fengycin | C15-C17 | 1489.797-1517.8283 | + | − | − | + |
| MB-Cit | | | | | | |
| Lichenysin | C12-C17 | 993.6594-1063.7376 | + | + | + | + |
| A/D1/D2/D3/ | | | | | | |
| G1/G2/G3/ | | | | | | |
| G4/G5 | | | | | | |

| Compound | RTI1243 | RTI1112 | FCC1598 | RTI1239 | RTI1241 | RTI1253 |
|---|---|---|---|---|---|---|
| dehydroxy | − | + | + | + | − | − |
| Fengycin | | | | | | |
| A/B/C/D/I/S | | | | | | |
| dehydroxy | − | + | + | + | − | − |
| Fengycin | | | | | | |
| H/MA/MB/ | | | | | | |
| MC | | | | | | |
| dehydroxyfengycin | − | + | + | + | − | − |
| MB- | | | | | | |
| Cit | | | | | | |
| Fengycin | − | − | + | + | − | − |
| A/B/C/D/I/S | | | | | | |
| Fengycin | − | + | − | + | − | − |
| H/MA/MB/ | | | | | | |
| MC | | | | | | |
| Fengycin | − | + | + | + | − | − |
| MB-Cit | | | | | | |
| Lichenysin | + | + | + | + | + | + |
| A/D1/D2/D3/ | | | | | | |
| G1/G2/G3/ | | | | | | |
| G4/G5 | | | | | | |

Strains RTI184 and RTI1112 (Group 2), which had identical BOX-PCR patterns, were found to produce the same type of Fengycin- and Dehydroxyfengycin-type metabolites, including dehydroxy Fengycin A/B/C/D/I/S, dehydroxy Fengycin H/MA/MB/MC, dehydroxyfengycin MB-Cit, Fengycin H/MA/MB/MC and Fengycin MB-Cit, but failed to produce the Fengycin A/B/C/D/I/S type metabolites. On the other hand, strain FCC1598 which also falls into Group 2, produced the Fengycin A/B/C/D/I/S type metabolites, but failed to produce the Fengycin H/MA/MB/MC-type metabolites. Surprisingly, strain RTI1243, which also belongs to Group 2, did not produce any of the Fengycin- and Dehydroxyfengycin-type metabolites. Finally, two of the strains belonging to Group 1 (RTI1242 and RTI1249) and two strains belonging to Group 3 (RTI1241 and RTI1253) failed to produce any of the Fengycin- and Dehydroxyfengycin-type metabolites, whereas the CH200 and RTI1239, belonging to Group 1 and Group 3, respectively, produced all of the Fengycin- and Dehydroxyfengycin-type metabolites. Based on these results, it was concluded that the synthesis of the different types of Fengycin- and Dehydroxyfengycin-type metabolites, including the newly identified citruline-containing metabolites, is strain dependent rather than intrinsic to the species Bacillus licheniformis. For example, even closely related Bacillus licheniformis Group 2 strains produced different Fengycin- and Dehydroxyfengycin-type molecules and one closely related Group 2 strain failed to produce any Fengycin- or Dehydroxyfengycin-type metabolites at all.

### REFERENCES

All publications, patent applications, patents, and other references cited herein are incorporated herein by reference in their entireties.

That which is claimed:

1. A planting matrix for benefiting plant growth, the planting matrix comprising a biologically pure culture of Bacillus licheniformis RTI184 deposited as ATCC No. PTA-121722, or a mutant thereof having all the identifying characteristics thereof, present in an amount suitable to benefit plant growth.

2. The planting matrix of claim 1, wherein the growth benefit of the plant is exhibited by improved seedling vigor, improved root development, improved plant growth, improved plant health, increased yield, improved appearance, or a combination thereof.

3. The planting matrix of claim 1, wherein the planting matrix is in the form of a potting soil.

4. The planting matrix of claim 1, wherein the Bacillus licheniformis RTI184 is in the form of spores.

5. The planting matrix of claim 4, wherein the Bacillus licheniformis RTI184 is present in an amount of from about 1.0×10⁵ CFU/g to about 1.0×10⁹ CFU/g.

6. The planting matrix of claim 4, wherein the Bacillus licheniformis RTI184 is present in an amount of from about 1.0×10⁶ CFU/g to about 1.0×10⁸ CFU/g.

7. The planting matrix of claim 1, wherein the pH of the planting matrix ranges from about pH 4 to about pH 8, from about pH 5 to about pH 7, or from about pH 5.5 to pH 6.5.

8. The planting matrix of claim 1, further comprising one or more of a microbial or a chemical insecticide, fungicide, nematicide, or bacteriocide, present in an amount suitable to benefit plant growth or health.

9. The planting matrix of claim 1, further comprising one or more of a plant extract, a plant growth regulator, or a fertilizer present in an amount suitable to benefit plant growth or health.

10. The planting matrix of claim 1, wherein the plant comprises Berry, Blueberry, Blackberry, Raspberry, Loganberry, Huckleberry, Cranberry, Gooseberry, Elderberry, Currant, Caneberry, Bushberry, Strawberry, Brassica Vegetables, Broccoli, Cabbage, Cauliflower, Brussels Sprouts, Collards, Kale, Mustard Greens, Kohlrabi, Cucurbit Vegetables, Cucumber, Cantaloupe, Melon, Muskmelon, Squash, Watermelon, Pumpkin, Eggplant, Bulb Vegetables, Onion, Garlic, Shallots, Fruiting Vegetables, Pepper, Tomato, Ground Cherry, Tomatillo, Okra, Grape, Herbs/Spices, Leafy Vegetables, Lettuce, Celery, Spinach, Parsley, Radicchio, Legumes/Vegetables (succulent and dried beans and peas), Sunflower, Root/Tuber and Corm Vegetables, Carrot, Potato, Sweet Potato, Cassave, Beets, Ginger, Horseradish, Radish, Ginseng, Turnip, Kiwi, Banana, herbs, Rosemary, Thyme, Cilantro, Oregano, Parsley, Sage, Mint, Lemon grass, Ornamental plants, Annuals, Poinsettia, Helichrysum, Geranium, Begonia, Bacopa, Chrysocephalum, Calibrachoa, Coleus, Cleome, Evolvulus, Angelonia, Argyranthemum, Nemesia, Osteospermum, Petunia, Pansiola, Pelargonium, Cyperus, Dalina, Dahlia, Dichondra, Ipomoea, Lantana, Lobularia, Lobelia, Euphorbia, Impatiens, Verbena, Scaevola, Sedum, Scirpus, Setaceum, Nemesia, Phlox, Torenia, Mecardonia, Perennials, Hydrangea, Clematis, Rosa, Buddleia, Salvia, Sedum, Sambucus, Hybiscus, Weigelia, Hardwood cuttings, Chestnuts, Oak, Maple, Stone Fruit, Apricot, Cherry, Nectarine, Peach, Plum, Prune, Citrus, Orange, Grapefruit, Lemon, Tangerine, Tangelo, or Pummelo.

11. A planting matrix for benefiting plant growth, the planting matrix comprising a biologically pure culture of Bacillus licheniformis CH200 deposited as Accession No. DSM 17236, or a mutant thereof having all the identifying characteristics thereof, present in an amount suitable to benefit plant growth.

12. The planting matrix of claim 11, wherein the growth benefit of the plant is exhibited by improved seedling vigor, improved root development, improved plant growth, improved plant health, increased yield, improved appearance, or a combination thereof.

13. The planting matrix of claim 11, wherein the planting matrix is in the form of a potting soil.

14. The planting matrix of claim 11, wherein the Bacillus licheniformis CH200 is in the form of spores.

15. The planting matrix of claim 14, wherein the Bacillus licheniformis CH200 is present in an amount of from about 1.0×10⁵ CFU/g to about 1.0×10⁹ CFU/g.

16. The planting matrix of claim 14, wherein the Bacillus licheniformis CH200 is present in an amount of from about 1.0×10⁶ CFU/g to about 1.0×10⁸ CFU/g.

17. The planting matrix of claim 11, wherein the pH of the planting matrix ranges from about pH 4 to about pH 8, from about pH 5 to about pH 7, or from about pH 5.5 to pH 6.5.

18. The planting matrix of claim 11, further comprising one or more of a microbial or a chemical insecticide, fungicide, nematicide, or bacteriocide, present in an amount suitable to benefit plant growth or health.

19. The planting matrix of claim 11, further comprising one or both of a plant extract, a plant growth regulator, or a fertilizer present in an amount suitable to benefit plant growth or health.

20. The planting matrix of claim 11, wherein the plant comprises Berry, Blueberry, Blackberry, Raspberry, Loganberry, Huckleberry, Cranberry, Gooseberry, Elderberry, Currant, Caneberry, Bush berry, Strawberry, Brassica Vegetables, Broccoli, Cabbage, Cauliflower, Brussels Sprouts, Collards, Kale, Mustard Greens, Kohlrabi, Cucurbit Vegetables, Cucumber, Cantaloupe, Melon, Muskmelon, Squash, Watermelon, Pumpkin, Eggplant, Bulb Vegetables, Onion, Garlic, Shallots, Fruiting Vegetables, Pepper, Tomato, Ground Cherry, Tomatillo, Okra, Grape, Herbs/Spices, Leafy Vegetables, Lettuce, Celery, Spinach, Parsley, Radicchio, Legumes/Vegetables (succulent and dried beans and peas), Sunflower, Root/Tuber and Corm Vegetables, Carrot, Potato, Sweet Potato, Cassave, Beets, Ginger, Horseradish, Radish, Ginseng, Turnip, Kiwi, Banana, herbs, Rosemary, Thyme, Cilantro, Oregano, Parsley, Sage, Mint, Lemon grass, Ornamental plants, Annuals, Poinsettia, Helichrysum, Geranium, Begonia, Bacopa, Chrysocephalum, Calibrachoa, Coleus, Cleome, Evolvulus, Angelonia, Argyranthemum, Nemesia, Osteospermum, Petunia, Pansiola, Pelargonium, Cyperus, Dalina, Dahlia, Dichondra, Ipomoea, Lantana, Lobularia, Lobelia, Euphorbia, Impatiens, Verbena, Scaevola, Sedum, Scirpus, Setaceum, Nemesia, Phlox, Torenia, Mecardonia, Perennials, Hydrangea, Clematis, Rosa, Buddleia, Salvia, Sedum, Sambucus, Hybiscus, Weigelia, Hardwood cuttings, Chestnuts, Oak, Maple, Stone Fruit, Apricot, Cherry, Nectarine, Peach, Plum, Prune, Citrus, Orange, Grapefruit, Lemon, Tangerine, Tangelo, or Pummelo.

21. A planting matrix for benefiting plant growth, the planting matrix comprising a biologically pure culture of a strain of Bacillus licheniformis, present in an amount suitable to benefit plant growth.
